(19) United States
(12) Patent Application Publication
(10) Pub. No.: US 2024/0037485 A1
(43) Pub. Date: Feb. 1, 2024

(54) BIG DATA MODELING AND ANALYZING METHOD AND SYSTEM FOR SHIPPING USER

(71) Applicant: HAINAN CHAOCHUAN E-COMMERCE CO., LTD., Haikou, Hainan (CN)

(72) Inventor: Jian Wu, Haikou, Hainan (CN)

(21) Appl. No.: 17/594,093

(22) PCT Filed: Aug. 31, 2021
(86) PCT No.: PCT/CN2021/115832

§ 371 Date: Oct. 1, 2021

(30) Foreign Application Priority Data
May 28, 2021 (CN) 202110591706.X

(51) Int. Cl. G06Q 10/083; G06Q 50/30; G06Q 10/0639; G06N 5/022

(52) U.S. Cl. CPC G06Q 10/083; G06Q 50/30; G06Q 10/06395; G06N 5/022

(57) ABSTRACT

A big data modeling and analyzing method and system for shipping users. The method is applied to a shipping date and cargo matching platform including a client side and a background system; the client side is used for managing information related to the shipping date or a cargo by users comprising a ship owner user and a cargo owner user; the background system is connected with the client side by a network and is used for matching shipping date information with cargo information and pushing the shipping date information and the cargo information.

### FIELD OF THE INVENTION

The present invention relates to the technical field of big data modeling and analyzing, in particular to a big data modeling and analyzing method and system for shipping users.

### BACKGROUND OF THE INVENTION

The booming shipping industry broadens the domestic coastal shipping market of dry bulk, and increases the transaction demand between cargo owners and ship owners; in order to promote transactions between the ship owners and the cargo owners, network platforms for matching shipping dates and cargos have come into the market; through these platforms, the ship owners can release shipping date information for the cargo owners to choose consignees, and the cargo owners can release cargo information for the ship owners to choose consignors; however, the existing network platforms only allow the ship owners and the cargo owners to release the shipping date information and the cargo information, and require the ship owners and the cargo owners themselves to browse the information to select and match the shipping dates and the cargos; despite automatic matches between the shipping dates and the cargos on some network platforms, what is considered is merely whether the load, time, etc. in the shipping date information can meet the requirements of the cargo information, but information like business conditions of the ship owners or the cargo owners is also an essential reference for the other party to choose business partners; therefore, the existing network platforms cannot provide comprehensive analysis and match functions for the ship owners or the cargo owners to further improve the success rate of transaction.

### BRIEF SUMMARY OF THE INVENTION

In view of this, the purpose of the present invention is to provide big data modeling and analyzing method and system for the shipping users, so as to overcome or at least partially solve the above problems in the prior art.

In a first aspect of the present invention, provided is the big data modeling and analyzing method for the shipping users, which is applied to a shipping date and cargo matching platform including a client side and a background system, wherein the client side is used for managing information related to the shipping date or the cargo by users including a ship owner user and a cargo owner user, and the background system is connected with the client side by a network and is used for matching and pushing shipping data information and cargo information; the method comprises:
S1, acquiring multi-dimensional activity record data of the cargo owner user, and constructing a cargo owner user model on the basis of the multi-dimensional activity record data of the cargo owner user;
S2, acquiring multi-dimensional activity record data of the ship owner user, and constructing a ship owner user model on the basis of the multi-dimensional activity record data of the ship owner user;
S3, calculating an evaluation score of the cargo owner according to the cargo owner user model, and grading the cargo owner user according to the evaluation score of the cargo owner; calculating an evaluation score of the ship owner according to the ship owner user model, and grading the ship owner user according to the evaluation score of the ship owner; and
S4, matching, on the basis of a grade of the cargo owner user and a grade of the ship owner user, cargo information released by the cargo owner user with the shipping date information released by the ship owner user, and pushing matched information to the cargo owner user and the ship owner user.

Further, the multi-dimensional activity record data of the cargo owner user comprise first-dimension activity record data of the cargo owner and second-dimension activity record data of the cargo owner, wherein the first-dimension activity record data of the cargo owner are local activity record data of the cargo owner, and the second-dimension activity record data of the cargo owner are third-party activity record data of the cargo owner; and
the multi-dimensional activity record data of the ship owner user comprise first-dimension activity record data of the ship owner and second-dimension activity record data of the ship owner, wherein the first-dimension activity record data of the ship owner are local activity record data of the ship owner, and the second-dimension activity record data of the ship owner are third-party activity record data of the ship owner.

Further, in S3, the calculation of the evaluation score of the cargo owner according to the cargo owner user model specifically comprises: acquiring a corresponding preset weight value of each activity record datum in the multi-dimensional activity record data of the cargo owner, and carrying out a weighted calculation on the multi-dimensional activity record data of the cargo owner, so as to obtain the evaluation score of the cargo owner; and
the calculation of evaluation score of the ship owner according to the ship owner user model specifically comprises: acquiring a corresponding preset weight value of each activity record datum in the multi-dimensional activity record data of the ship owner, and carrying out the weighted calculation on the multi-dimensional activity record data of the ship owner, so as to obtain the evaluation score of the ship owner.

Further, in S4, the process of matching, on the basis of the grade of the cargo owner user and the grade of the ship owner user, the cargo information released by the cargo owner user with the shipping date information released by the ship owner user, and pushing matched information to the cargo owner user and the ship owner user specifically comprises:
S401, screening the shipping date information released by the ship owner user according to the cargo information released by the cargo owner user, and removing the shipping date information with time and load information not matching the cargo information;
S402, rescreening the screened shipping date information according to information about an evaluation score demand of the cargo owner user on the ship owner user, and removing the shipping date information with an evaluation score of the ship owner user lower than the evaluation score demand;
S403, acquiring information about the evaluation score demand of the ship owner user corresponding to the rescreened shipping date information on the cargo owner user, determining whether the evaluation score of the cargo owner user meets a requirement for score demand information of the cargo owner user on the cargo owner user, and if yes, sending the rescreened shipping date information to the cargo owner user; and
S404, acquiring the shipping date information selected by the cargo owner user from the rescreened shipping date information, and sending the cargo information to the ship owner user corresponding to the selected shipping date information.

Further, the method comprises the following steps between S2 and S3:
S21, acquiring preference information of the cargo owner user for each activity record datum in the multi-dimensional activity record data of the ship owner user; and
S22, adjusting the corresponding preset weight value of each activity record datum in the multi-dimensional activity record data of the ship owner to a temporary weight value according to the preference information, and carrying out the weighted calculation on the multi-dimensional activity record data of the ship owner on the basis of the temporary weight value, so as to acquire the evaluation score of the ship owner.

Further, the method comprises the following steps:
S5, constructing, on the basis of a machine learning algorithm, a training model for predicting the preference information according to historical cargo information and historical preference information; and
S6, predicting, by the training model, the preference information according to the cargo information, and carrying out the weighted calculation on the multi-dimensional activity record data of the ship owner according to a predicted result.

Further, S5 specifically comprises the following steps:
S501: acquiring the historical cargo information released by a plurality of the cargo owner users and the historical preference information for each activity record datum in the multi-dimensional activity record data of the ship owner user;
S502, analyzing the historical cargo information and corresponding historical preference information, and determining a significant factor in the historical cargo information, wherein the significant factor is the content of the historical cargo information which affects the historical preference information; and
S503, constructing a classifier according to the significant factor and the historical preference information, and constructing the training model on the basis of the machine learning algorithm, wherein the training model is used for predicting corresponding preference information according to the significant factor in the cargo information.

Further, S6 specifically comprises the following steps:
S601, analyzing and extracting, in a next calculation of the evaluation score of the ship owner according to the ship owner user model, the significant factor in the cargo information released by the cargo owner user, and inputting an extracted significant factor into the training model, so as to obtain predicted preference information; and
S602, adjusting the corresponding preset weight value of each activity record datum in the multi-dimensional activity record data of the ship owner to the temporary weight value according to the predicted preference information, and carrying out the weighted calculation on the multi-dimensional activity record data of the ship owner on the basis of the temporary weight value, so as to acquire the evaluation score of the ship owner.

On a second aspect of the present invention, provided is the big data modeling and analyzing system for the shipping users, which is applied to the shipping date and cargo matching platform including the client side and the background system, wherein the client side is used for managing information related to the shipping date or the cargo by users including the ship owner user and the cargo owner user, and the background system is connected with the client side by a network and is used for matching and pushing shipping data information and cargo information. The system comprises:
a cargo owner model constructing module for acquiring multi-dimensional activity record data of the cargo owner user, and constructing the cargo owner user model on the basis of the multi-dimensional activity record data of the cargo owner user;
a ship owner model constructing module for acquiring multi-dimensional activity record data of the ship owner user, and constructing the ship owner user model on the basis of the multi-dimensional activity record data of the ship owner user;
an evaluating and grading module for calculating the evaluation score of the cargo owner according to the cargo owner user model, grading the cargo owner user according to the evaluation score of the cargo owner, calculating the evaluation score of the ship owner according to the ship owner user model, and grading the ship owner user according to the evaluation score of the ship owner; and
a matching module for matching, on the basis of the grade of the cargo owner user and the grade of the ship owner user, cargo information released by the cargo owner user with shipping date information released by the ship owner user, and pushing matched information to the cargo owner user and the ship owner user.

Compared with the prior art, the present invention has the beneficial effects:

According to the big data modeling and analyzing method and system for shipping users provided in the present invention, the cargo owner user model and the ship owner user model may be respectively constructed according to the multi-dimensional activity record data of the cargo owner user and the multi-dimensional activity record data of the ship owner user; the evaluation score of the cargo owner and the evaluation score of the ship owner may be respectively calculated on the basis of the two models; the corresponding cargo owner user and ship owner user are graded on the basis of the evaluation scores; the cargo information and the shipping date information released by both parties are matched according to the grades, and the matched information is pushed to the corresponding cargo owner user and ship owner user according to a matching result, such that on the basis of requirements of the both parties, big data generated on the basis of user activities further help the user to screen proper business cooperation partners, which is conducive to increase the success rate of transaction.

### BRIEF DESCRIPTION OF THE FIGURES

In order to describe the technical solutions in the embodiments of the present invention more clearly, the accompanying drawings required for describing the embodiments are briefly described below. Obviously, the accompanying drawings in the following description show merely preferred embodiments of the present invention, and a person of ordinary skill in the art would also be able to derive other accompanying drawings from these accompanying drawings without creative efforts.

FIG. 1 is a schematic diagram of an overall flow of the big data modeling and analyzing method for shipping users provided in one embodiment of the present invention.

FIG. 2 is a schematic diagram of a matching flow of cargo information and shipping date information according to one embodiment of the present invention.

FIG. 3 is a schematic diagram of an overall flow of the big data modeling and analyzing method for shipping users provided in another embodiment of the present invention.

FIG. 4 is a schematic diagram of an overall flow of the big data modeling and analyzing method for shipping users provided in another embodiment of the present invention.

FIG. 5 is a schematic diagram of an overall structure of the big data modeling and analyzing system for shipping users provided in one embodiment of the present invention.

In the accompanying drawings, 1. cargo owner model constructing module, 2. ship owner model constructing module, 3. evaluating and grading module, 4. matching module.

### DETAILED DESCRIPTION OF THE INVENTION

The principles and features of the present invention will be described below with reference to the accompanying drawings, and the listed embodiments are only intended to illustrate the present invention but are not intended to limit the scope of the present invention.

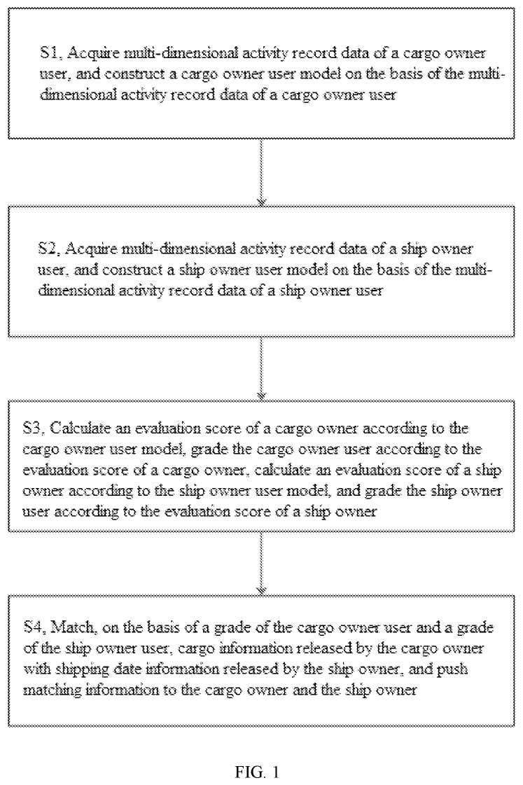

With reference to FIG. 1, provided is the big data modeling and analyzing method for shipping users, which is applied to the shipping date and cargo matching platform including the client side and a background system; the client side is used for managing information related to the shipping date or the cargo by users including the ship owner user and the cargo owner user; specifically, the ship owner user may release and manage shipping date information and view the information related to the cargo by means of the client side, and the cargo owner user may release and manage cargo information and view the information related to the shipping date by means of the client side; the background system is connected with the client side by the network and is used for matching and pushing the shipping data information and the cargo information between the different client sides, namely, the users corresponding to the different client sides. The method comprises:
S1, acquiring the multi-dimensional activity record data of the cargo owner user, and construct the cargo owner user model on the basis of the multi-dimensional activity record data of the cargo owner user.

Illustratively, the multi-dimensional activity record data of the cargo owner user comprises first-dimension activity record data of the cargo owner and second-dimension activity record data of the cargo owner. The first-dimension activity record data of the cargo owner is local activity record data of the cargo owner, and the second-dimension activity record data of the cargo owner is third-party activity record data of the cargo owner. The local activity record data of the cargo owner is activity record data generated when the cargo owner user carries out various operations on the shipping date and cargo matching platform, such as a login frequency, a communication frequency, a volume of transaction, and a cargo supply failure condition, where the communication frequency is a frequency of online communication between the cargo owner user and the ship owner user through the platform. The third-party activity record data of the cargo owner is activity record data generated by the cargo owner user on a third-party website or platform, such as a telephone answering frequency of the cargo owner user acquired by means of an operator, an overdue credit reporting frequency of the cargo owner user acquired by means of a bank, and an enterprise business condition corresponding to the cargo owner user acquired by means of an enterprise industrial and commercial information inquiry platform.

In this embodiment, the cargo owner user model is constructed for each cargo owner user and is used for recording a user name, a name, the multi-dimensional activity record data, the evaluation score of the cargo owner, grade information and other content of the cargo owner user, so as to reflect comprehensive situations of the cargo owner user from multiple dimensions.
S2, acquiring the multi-dimensional activity record data of the ship owner user, and construct the ship owner user model on the basis of the multi-dimensional activity record data of the ship owner user.

Illustratively, the multi-dimensional activity record data of the ship owner user comprises first-dimension activity record data of the ship owner and second-dimension activity record data of the ship owner. The first-dimension activity record data of the ship owner is local activity record data of the ship owner, and the second-dimension activity record data of the ship owner is third-party activity record data of the ship owner. The local activity record data of the ship owner is activity record data generated when the ship owner user carries out various operations on the shipping date and cargo matching platform, such as the login frequency, the shipping date self-updating frequency, the communication frequency and the volume of transaction, where the communication frequency is the frequency of online communication between the cargo owner user and the ship owner user by means of the platform. The third-party activity record data of the ship owner is activity record data generated by the ship owner user on the third-party website or platform, such as the telephone answering frequency acquired by means of an operator, the ship operation data of the ship owner acquired by means of a shipping company or relevant websites, and the overdue credit reporting frequency of the ship owner user acquired by means of a bank.

In this embodiment, the ship owner user model is constructed for each ship owner user and is used for recording the user name, the name, the multi-dimensional activity record data, the evaluation score of the ship owner, the grade information and other content of the ship owner user, so as to reflect comprehensive situations of the ship owner user from multiple dimensions.
S3, calculating the evaluation score of the cargo owner according to the cargo owner user model; grading the cargo owner user according to the evaluation score of the cargo owner; calculating an evaluation score of the ship owner according to the ship owner user model, and grade the ship owner user according to the evaluation score of the ship owner.
S4, matching, on the basis of the grade of the cargo owner user and the grade of the ship owner user, cargo information released by the cargo owner user with shipping date information released by the ship owner user, and pushing matched information to the cargo owner user and the ship owner user.

According to the big data modeling and analyzing method and system for shipping users provided in this embodiment, the cargo owner user model and the ship owner user model may be respectively constructed according to the multi-dimensional activity record data of the cargo owner user and the multi-dimensional activity record data of the ship owner user; the evaluation score of the cargo owner and the evaluation score of the ship owner may be respectively calculated on the basis of the two models; the corresponding cargo owner user and ship owner user are graded on the basis of the evaluation scores; the cargo information and the shipping date information released by both parties are matched according to the grades, and the matched information is pushed to the corresponding cargo owner user and ship owner user according to a matching result, such that on the basis of requirements of the both parties, big data generated on the basis of user activities further helps the user to screen proper business cooperation partners, which is conducive to increase the success rate of transaction.

As a preferred method of this embodiment, in S3, the step of calculating the evaluation score of the cargo owner according to the cargo owner user model specifically comprises: acquiring the corresponding preset weight value of each activity record datum in the multi-dimensional activity record data of the cargo owner, and carrying out the weighted calculation on the multi-dimensional activity record data of the cargo owner, so as to obtain the evaluation score of the cargo owner. Meanwhile, the step of calculating an evaluation score of the ship owner according to the ship owner user model specifically comprises: acquiring the corresponding preset weight value of each activity record datum in the multi-dimensional activity record data of the ship owner, and carrying out the weighted calculation on the multi-dimensional activity record data of the ship owner, so as to obtain the evaluation score of the ship owner.

Illustratively, each activity record datum in the multi-dimensional activity record data of the cargo owner and each activity record datum in the multi-dimensional activity record data of the ship owner correspond to one preset weight value, all the data is subjected to weighted calculation according to the corresponding preset weight values, then added, and divided by the number of items of the data, so as to obtain the evaluation score of the cargo owner/evaluation score of the ship owner. For activity record data with an original meaning that is not expressed by numbers, such as an enterprise business condition or a ship operation condition, different numbers may be used to refer to the different enterprise business conditions, thus facilitating calculation.

In this embodiment, the weighted calculation is carried out according to significances of different activity record data, such that the cargo owner user/ship owner user may be comprehensively evaluated by means of a single index of the evaluation score of the cargo owner/evaluation score of the ship owner. The cargo owner user and the ship owner user are graded according to the evaluation scores, and the higher the grade is, the better the overall business condition, the credit condition and the communication efficiency of the corresponding user are, so that the users may be screened according to the grade subsequently.

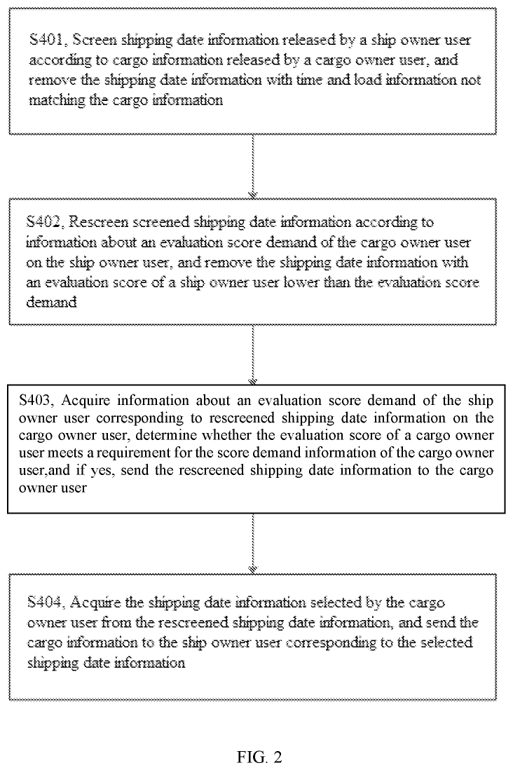

As the preferred method of this embodiment, with reference to FIG. 2, in S4, the steps of matching, on the basis of the grade of the cargo owner user and the grade of the ship owner user, cargo information released by the cargo owner user with shipping date information released by the ship owner user, and pushing matched information to the cargo owner user and the ship owner user specifically comprises:
S401, screening the shipping date information released by the ship owner user according to the cargo information released by the cargo owner user, and remove the shipping date information with time and load information not matching the cargo information.

Illustratively, when the shipping date information released by the ship owner user fails to meet time information such as a freight duration required in the cargo information released by the cargo owner user, or the load in the shipping date information released by the ship owner user fails to meet a cargo weight in the cargo information, the shipping date information which fails to meet requirements is screened out.
S402, rescreening the screened shipping date information according to information about the evaluation score demand of the cargo owner user on the ship owner user, and removing the shipping date information with an evaluation score of the ship owner user lower than the evaluation score demand.

Illustratively, in this step, the information about the evaluation score demand of the cargo owner user on the ship owner user needs to be acquired in advance and reflects a corresponding evaluation score demand of the cargo owner user on the ship owner user. For the shipping date information screened in S401, when the corresponding evaluation score of the ship owner user fails to meet the requirement of the cargo owner user, the shipping date information that fails to meet the requirement is screened out.
S403, acquiring information about the evaluation score demand of the ship owner user corresponding to the rescreened shipping date information on the cargo owner user, determining whether the evaluation score of the cargo owner user meets a requirement for the score demand information of the cargo owner user, and if yes, sending the rescreened shipping date information to the cargo owner user.

In S403, the information about the evaluation score demand of the ship owner user corresponding to the rescreened shipping date information on the cargo owner user is acquired in advance and reflects the evaluation score demand of the ship owner user on the cargo owner user; if the evaluation score of the cargo owner user also meets the requirement of the ship owner user after the rescreening, then the rescreened shipping date information may be sent to the cargo owner user for the cargo owner user to select the consignee.
S404, acquiring the shipping date information selected by the cargo owner user from the rescreened shipping date information, and sending the cargo information to the ship owner user corresponding to the selected shipping date information. The ship owner user may determine whether to accept a commission or not according to the cargo information or may communicate with the cargo owner user online by means of the platform to determine transaction details.

In this embodiment, the shipping date information with the shipping date and the comprehensive conditions of the ship owner meeting requirements of the cargo owner user is acquired by a double screening to be selected by the cargo owner user. After the cargo owner user selects the consignee, whether the comprehensive conditions of the cargo owner user meet requirements of the ship owner user or not is determined by means of the evaluation score of the cargo owner user, such that the comprehensive conditions of both parties during final transaction meet the requirements of the both parties, therefore, the transaction is facilitated, a transaction efficiency is improved, and a situation that the cargo owner is not prone to find a proper shipping date, resulting in a cargo supply failure, or a ship of the ship owner remains idle for a long time is avoided.

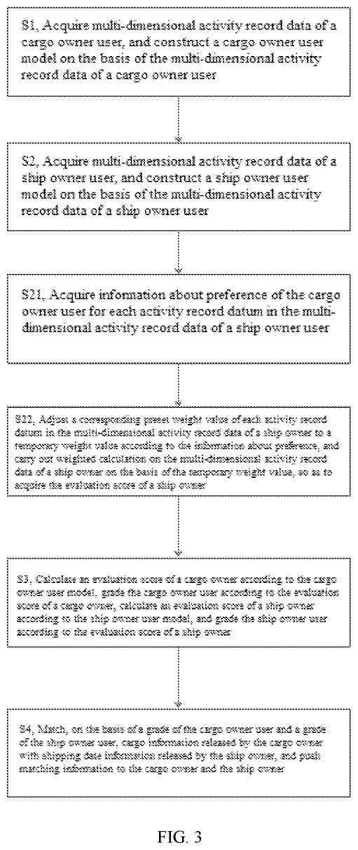

As the preferred method of this embodiment, with reference to FIG. 3, the method further comprises the following steps between S2 and S3:
S21, acquiring the preference information of the cargo owner user for each activity record datum in the multi-dimensional activity record data of the ship owner user.

Illustratively, the preference information is used to describe a preference degree of the cargo owner user to each activity record datum in the multi-dimensional activity record of the ship owner user, and the higher the preference degree to a certain activity record datum, the higher a weight of the activity record data from the point of the cargo owner user.
S22, adjust the corresponding preset weight value of each activity record datum in the multi-dimensional activity record data of the ship owner to the temporary weight value according to the preference information, and carry out the weighted calculation on the multi-dimensional activity record data of the ship owner on the basis of the temporary weight value, so as to acquire the evaluation score of the ship owner.

In this embodiment, the evaluation score of the ship owner is calculated after the temporary weight value is adjusted on the basis of the preference degree of the cargo owner user to the activity record data of different ship owners, and different cargo owners have different preference degrees to the communication efficiency, the ship operation condition, a credit degree, etc. of the ship owner; the evaluation score of the ship owner is calculated on the basis of the preference information of the cargo owner, such that a final evaluation score and grade may adapt to different requirements of different cargo owners, so a personalized evaluation is realized, and the transaction is further facilitated.

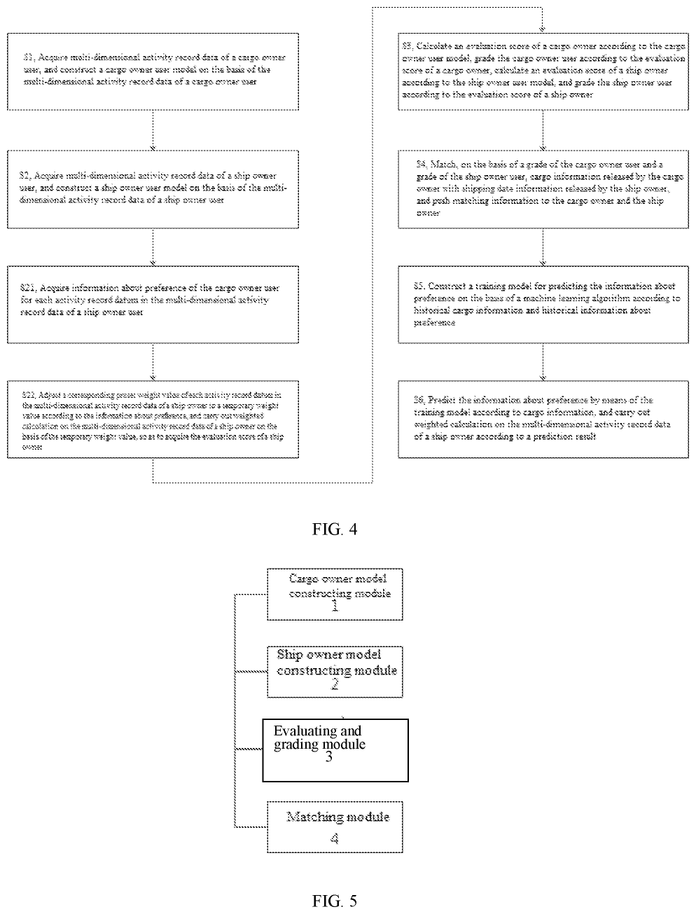

As the preferred method of this embodiment, with reference to FIG. 4, the method further comprises the following steps:
S5, constructing, on the basis of the machine learning algorithm, the training model for predicting the preference information according to historical cargo information and historical preference information.
S6, predicting, by the training model, the preference information according to the cargo information, and carry out weighted calculation on the multi-dimensional activity record data of the ship owner according to the predicted result.

The purpose of this embodiment is to construct the training model that may be used for predicting the preference information on the basis of the machine learning algorithm, such that the corresponding preference information may be automatically predicted according to the cargo information; moreover, the cargo owner user does not need to repeatedly provide the preference information, such that a calculation processing efficiency is accelerated, and a user experience of the users is improved.

Specifically, S5 specifically comprises the following steps:
S501: acquiring historical cargo information released by a plurality of the cargo owner users and historical preference information for each activity record datum in the multi-dimensional activity record data of the ship owner user. Each piece of historical preference information corresponds to one piece of the historical cargo information.
S502, analyzing the historical cargo information and corresponding historical preference information, and determining the significant factor in the historical cargo information, where the significant factor is content of the historical cargo information which affects the historical preference information.
S503, constructing the classifier according to the significant factor and the historical preference information, and constructing the training model on the basis of the machine learning algorithm, where the training model is used for predicting corresponding preference information according to the significant factor in the cargo information.

Illustratively, different cargo owners may have different preference degrees on the multi-dimensional activity record data of the ship owner, which may be caused by commercial considerations of the cargo owners themselves, for example, some cargo owners pay attention to the communication efficiency with the ship owner, while some cargo owners pay attention to a credit of the ship owner, which may directly lead to the situations that when some cargo owner identities (ID) appear in the cargo information, the corresponding preference information may also emphasize a certain activity record datum of the ship owner; or by consideration of information of goods, time, and other information shown in the cargo that may influence the preference information. In this embodiment, information which repeatedly appears most frequently in the corresponding historical cargo information under different preference information is determined and may be taken as the significant factor affecting the historical preference information, namely, when the cargo information contains the significant factor, the corresponding preference information is easy to determine, and the training model predicts the preference information according to the significant factor on the basis of this principle, such that the cargo owner does not need to repeatedly provide the preference information.

S6 specifically comprises the following steps:
S601, analyzing and extracting, in the next calculation of the evaluation score of the ship owner according to the ship owner user model, the significant factor in the cargo information released by the cargo owner user, and inputting an extracted significant factor into the training model, so as to obtain the predicted preference information; and
S602, adjusting the corresponding preset weight value of each activity record datum in the multi-dimensional activity record data of the ship owner to the temporary weight value according to the predicted preference information, and carry out the weighted calculation on the multi-dimensional activity record data of the ship owner on the basis of the temporary weight value, so as to obtain the evaluation score of the ship owner.

In this embodiment, the evaluation score of the ship owner is obtained by carrying out the weighted calculation on the predicted preference information, such that on the one hand, the evaluation score of the ship owner may better reflect the evaluation grade of the ship owner under preference differences of the different cargo owners. On the other hand, the cargo owner does not need to repeatedly provide the preference information, such that a result may meet the requirements of users, the users are unaware during the process, and the user experience of the users can be further improved.

In the basis of the same inventive concept as the foregoing embodiments, provided is the big data modeling and analyzing system for shipping users in another embodiment of the present invention, which is applied to the shipping date and cargo matching platform including the client side and the background system, wherein the client side is used for managing information related to the shipping date or the cargo by users including the ship owner user and the cargo owner user, and the background system is connected with the client side by the network for matching and pushing shipping data information and cargo information. With reference to FIG. 5, the system specifically comprises:
the cargo owner model constructing module 1 for acquiring multi-dimensional activity record data of the cargo owner user, and constructing the cargo owner user model on the basis of the multi-dimensional activity record data of the cargo owner user, wherein the multi-dimensional activity record data of the cargo owner user comprises the first-dimension activity record data of the cargo owner and second-dimension activity record data of the cargo owner; the first-dimension activity record data of the cargo owner is the local activity record data of the cargo owner, and the second-dimension activity record data of the cargo owner is the third-party activity record data of the cargo owner;
the ship owner model constructing module 2 for acquiring multi-dimensional activity record data of the ship owner user, and constructing the ship owner user model on the basis of the multi-dimensional activity record data of the ship owner user, wherein the multi-dimensional activity record data of the ship owner user comprises the first-dimension activity record data of the ship owner and the second-dimension activity record data of the ship owner; the first-dimension activity record data of the ship owner is the local activity record data of the ship owner, and the second-dimension activity record data of the ship owner is the third-party activity record data of the ship owner;
the evaluating and grading module 3 for calculating the evaluation score of the cargo owner according to the cargo owner user model, grading the cargo owner user according to the owner evaluation score, calculating the evaluation score of the ship owner according to the ship owner user model, and grading the ship owner user according to the evaluation score of the ship owner; and
the matching module 4 for matching, on the basis of the grade of the cargo owner user and the grade of the ship owner user, the cargo information released by the cargo owner user with the shipping date information released by the ship owner user, and pushing matched information to the cargo owner user and the ship owner user.

Optionally, the evaluating and grading module 3 specifically comprises:
the cargo owner evaluating and grading module for acquiring the corresponding preset weight value of each activity record datum in the multi-dimensional activity record data of the cargo owner, and carrying out the weighted calculation on the multi-dimensional activity record data of the cargo owner, so as to obtain the evaluation score of the cargo owner;
the ship owner evaluating and grading module for acquiring the corresponding preset weight value of each activity record datum in the multi-dimensional activity record data of the ship owner, and carrying out the weighted calculation on the multi-dimensional activity record data of the ship owner, so as to obtain the evaluation score of the ship owner.

Optionally, the matching module 4 specifically comprises:
a primary screening module for screening the shipping date information released by the ship owner user according to the cargo information released by the cargo owner user, and removing the shipping date information with time and load information not matching the cargo information;
a rescreening module for rescreening the screened shipping date information according to information about the evaluation score demand of the cargo owner user on the ship owner user, and removing the shipping date information with the evaluation score of the ship owner user lower than the evaluation score demand;
a first sending module for acquiring information about the evaluation score demand of the ship owner user corresponding to rescreened shipping date information on the cargo owner user, determining whether the evaluation score of the cargo owner user meets the requirement for the score demand information of the cargo owner user, and if yes, sending the rescreened shipping date information to the cargo owner user; and
a second sending module for acquiring the shipping date information selected by the cargo owner user from the rescreened shipping date information, and sending the cargo information to the ship owner user corresponding to the selected shipping date information.

Optionally, the system further comprises an acquisition module and an adjustment module.

The acquisition module is used for acquiring the preference information of the cargo owner user for each activity record datum in the multi-dimensional activity record data of the ship owner user.

The adjustment module is used for adjusting the corresponding preset weight value of each activity record datum in the multi-dimensional activity record data of the ship owner to the temporary weight value according to the preference information, and carrying out weighted calculation on the multi-dimensional activity record data of the ship owner on the basis of the temporary weight value, so as to acquire the evaluation score of the ship owner.

Optionally, the system further comprises a training model constructing module and a weight predicting module.

Specifically, the training model constructing module comprises:
an acquisition submodule for acquiring historical cargo information released by a plurality of the cargo owner users and historical preference information for each activity record datum in the multi-dimensional activity record data of the ship owner user;
an analysis submodule for analyzing the historical cargo information and corresponding historical preference information, and determining the significant factor in the historical cargo information, wherein the significant factor is content of the historical cargo information which affects the historical preference information; and
a constructing submodule for constructing the classifier according to the significant factor and the historical preference information, and constructing the training model on the basis of the machine learning algorithm, wherein the training model is used for predicting corresponding preference information according to the significant factor in the cargo information.

The weight predicting module specifically comprises:
a predicting submodule for analyzing and extracting, in a next calculation of the evaluation score of the ship owner according to the ship owner user model, the significant factor in the cargo information released by the cargo owner user, and inputting an extracted significant factor into the training model, so as to obtain the predicted preference information; and
a weighting submodule for adjusting the corresponding preset weight value of each activity record datum in the multi-dimensional activity record data of the ship owner to the temporary weight value according to the predicted preference information, and carrying out weighted calculation on the multi-dimensional activity record data of the ship owner on the basis of the temporary weight value, so as to acquire the evaluation score of the ship owner.

The system embodiment is used for executing the method described in the above method embodiment, and the working principle and technical effect thereof can be obtained by referring to that of the above method embodiment, and the detailed description is omitted here.

The above descriptions are merely the preferred embodiments of the present utility model but not intended to limit the present invention; any modifications, equivalent replacements, improvements, etc. made within the spirit and principles of the present invention should be included within the scope of protection of the present invention.

1. A big data modeling and analyzing method for shipping users, wherein the method is applied to a shipping date and cargo matching platform comprising a client side and a background system; the client side is used for managing information related to the shipping date or a cargo by users comprising a ship owner user and a cargo owner user; the background system is connected with the client side by a network and is used for matching shipping date information with cargo information and pushing the shipping date information and the cargo information; the method comprises:
S1, acquiring multi-dimensional activity record data of the cargo owner user, and constructing a cargo owner user model on the basis of the multi-dimensional activity record data of the cargo owner user;
S2, acquiring multi-dimensional activity record data of the ship owner user, and constructing a ship owner user model on the basis of the multi-dimensional activity record data of the ship owner user;
S3, calculating an evaluation score of the cargo owner according to the cargo owner user model, grading the cargo owner user according to the evaluation score of the cargo owner, calculating an evaluation score of the ship owner according to the ship owner user model, and grading the ship owner user according to the evaluation score of the ship owner; and
S4, matching, on the basis of a grade of the cargo owner user and a grade of the ship owner user, cargo information released by the cargo owner user with the shipping date information released by the ship owner user, and pushing matched information to the cargo owner user and the ship owner user.

2. The method according to claim 1, wherein the multi-dimensional activity record data of the cargo owner user comprises first-dimension activity record data of the cargo owner and second-dimension activity record data of the cargo owner; the first-dimension activity record data of the cargo owner is local activity record data of the cargo owner, and the second-dimension activity record data of the cargo owner is third-party activity record data of the cargo owner; and
the multi-dimensional activity record data of the ship owner user comprises first-dimension activity record data of the ship owner and second-dimension activity record data of the ship owner; the first-dimension activity record data of the ship owner is local activity record data of the ship owner, and the second-dimension activity record data of the ship owner is third-party activity record data of the ship owner.

3. The method according to claim 1, wherein in S3, the step of calculating the evaluation score of the cargo owner according to the cargo owner user model specifically comprises: acquiring a corresponding preset weight value of each activity record datum in the multi-dimensional activity record data of the cargo owner, and carrying out a weighted calculation on the multi-dimensional activity record data of the cargo owner, so as to obtain the evaluation score of the cargo owner; and
the step of calculating the evaluation score of the ship owner according to the ship owner user model specifically comprises: acquiring a corresponding preset weight value of each activity record datum in the multi-dimensional activity record data of the ship owner, and carrying out the weighted calculation on the multi-dimensional activity record data of the ship owner, so as to obtain the evaluation score of the ship owner.

4. The method according to claim 1, wherein in S4, the step of matching, on the basis of the grade of the cargo owner user and the grade of the ship owner user, the cargo information released by the cargo owner user with the shipping date information released by the ship owner user, and pushing the matched information to the cargo owner user and the ship owner user specifically comprises:
S401, screening the shipping date information released by the ship owner user according to the cargo information released by the cargo owner user, and removing the shipping date information with time and load information not matching the cargo information;
S402, rescreening screened shipping date information according to information about an evaluation score demand of the cargo owner user on the ship owner user, and removing the shipping date information with an evaluation score of the ship owner user lower than the evaluation score demand;
S403, acquiring information about the evaluation score demand of the ship owner user corresponding to the rescreened shipping date information on the cargo owner user, determining whether the evaluation score of the cargo owner user meets a requirement for score demand information of the cargo owner user, and if yes, sending the rescreened shipping date information to the cargo owner user; and
S404, acquiring the shipping date information selected by the cargo owner user from the rescreened shipping date information, and sending the cargo information to the ship owner user corresponding to the selected shipping date information.

5. The method according to claim 3, wherein the following steps are further comprised between S2 and S3:
S21, acquiring the preference information of the cargo owner user for each activity record datum in the multi-dimensional activity record data of the ship owner user; and
S22, adjusting the corresponding preset weight value of each activity record datum in the multi-dimensional activity record data of the ship owner to the temporary weight value according to the preference information, and carrying out the weighted calculation on the multi-dimensional activity record data of the ship owner on the basis of the temporary weight value, so as to acquire the evaluation score of the ship owner.

6. The method according to claim 5, wherein it further comprises:
S5, constructing, on the basis of a machine learning algorithm, a training model for predicting preference information according to historical cargo information and historical preference information; and
S6, predicting, by the training model, the preference information according to the cargo information, and carrying out the weighted calculation on the multi-dimensional activity record data of the ship owner according to a predicted result.

7. The method according to claim 6, wherein S5 specifically comprises:
S501: acquiring historical cargo information released by a plurality of the cargo owner users and historical preference information for each activity record datum in the multi-dimensional activity record data of the ship owner user;
S502, analyzing the historical cargo information and corresponding historical preference information, and determining a significant factor in the historical cargo information, wherein the significant factor is content of the historical cargo information which affects the historical preference information; and
S503: constructing a classifier according to the significant factor and the historical preference information, and constructing the training model on the basis of the machine learning algorithm, wherein the training model is used for predicting corresponding preference information according to the significant factor in the cargo information.

8. The method according to claim 7, wherein S6 specifically comprises:
S601, analyzing and extracting, in a next calculation of the evaluation score of the ship owner according to the ship owner user model, the significant factor in the cargo information released by the cargo owner user, and inputting the extracted significant factor into the training model, so as to obtain predicted preference information; and
S602, adjusting the corresponding preset weight value of each activity record datum in the multi-dimensional activity record data of the ship owner to the temporary weight value according to the predicted preference information, and carrying out the weighted calculation on the multi-dimensional activity record data of the ship owner on the basis of the temporary weight value, so as to acquire the evaluation score of the ship owner.

9. A big data modeling and analyzing system for shipping users, wherein the system is applied to the shipping date and cargo matching platform comprising the client side and the background system; the client side is used for managing information related to the shipping date or the cargo by users comprising the ship owner user and the cargo owner user; the background system is connected with the client side by the network and is used for matching the shipping date information with the cargo information and pushing the shipping date information and the cargo information; and the system specifically comprises:
a cargo owner model constructing module for acquiring the multi-dimensional activity record data of the cargo owner user, and constructing the cargo owner user model on the basis of the multi-dimensional activity record data of the cargo owner user;
a ship owner model constructing module for acquiring the multi-dimensional activity record data of the ship owner user, and constructing the ship owner user model on the basis of the multi-dimensional activity record data of the ship owner user;
an evaluating and grading module for calculating the evaluation score of the cargo owner according to the cargo owner user model, grading the cargo owner user according to the evaluation score of the cargo owner, calculating the evaluation score of the ship owner according to the ship owner user model, and grading the ship owner user according to the evaluation score of the ship owner; and
a matching module for matching, on the basis of the grade of the cargo owner user and the grade of the ship owner user, the cargo information released by the cargo owner user with the shipping date information released by the ship owner user, and pushing the matched information to the cargo owner user and the ship owner user.
